(19) United States
(12) Patent Application Publication
(10) Pub. No.: US 2004/0239589 A1
(43) Pub. Date: Dec. 2, 2004

(54) Plasma display panel apparatus and drive method thereof

(76) Inventors: Masaki Nishimura, Takatsuki-shi (JP); Hiroyuki Tachinaba, Toyonaka-shi (JP); Toru Ando, Osaka-shi (JP); Nobuaki Nagao, Katano-shi (JP)

Correspondence Address: SNELL & WILMER LLP, 1920 MAIN STREET, SUITE 1200, IRVINE, CA, 92614-7230, US

(21) Appl. No.: 10/483,476

(22) PCT Filed: Jul. 23, 2002
(86) PCT No.: PCT/JP02/07411

(30) Foreign Application Priority Data
Jul. 24, 2001 (JP) 2001-222892

(51) Int. Cl. G09G 3/28

(52) U.S. Cl. 345/60

(57) ABSTRACT

A driving method is for a PDP device including a PDP unit and a driving unit driving the PDP unit based on the intra-field time division gradation display technique. The PDP unit includes first display-electrode pairs each being a scan electrode and a sustain electrode arranged in a first order and second display-electrode pairs each being a scan electrode and a sustain electrode arranged in a second order opposite to the first order, arranged in parallel, thereby scan electrodes in adjacent pairs are adjacent to each other and sustain electrodes in adjacent pairs are adjacent to each other. The method includes: during an address period at driving, a first step of applying scan pulses to scan electrodes selected from the first display-electrode pairs in the first order direction; and a second step of applying scan pulses to scan electrodes selected from the second display-electrode pairs in the second order direction.

### TECHNICAL FIELD

The present invention relates to a plasma display panel device for use in image displays such as computers and televisions, and also relates to a method for driving the plasma display panel device.

### BACKGROUND ART

A plasma display panel (PDP) device includes a PDP unit 10, one example of which is shown in a partial perspective view of FIG. 1. The PDP unit 10 is formed by placing two thin glass plates, i.e., a front glass plate 11 and a back glass plate 12, so as to face each other with a plurality of barrier ribs 15 interposed between them, placing phosphor layers 16 of red (R), green (G), and blue (B) each between adjacent barrier ribs 15, and enclosing a discharge gas into a discharge space formed between the glass plates 11 and 12. On the surface of the front glass plate 11, a plurality of pairs of display electrodes (i.e., pairs of scan electrodes 19a₁ to 19a_{N} and sustain electrodes 19b₁ to 19b_{N}) one of which is a pair of a scan electrode 19a₁ and a sustain electrode 19b₁ are formed, and these display electrodes are covered by a dielectric layer 17 and then by a protective layer 18. On the surface of the back glass plate 12, a plurality of data electrodes 14₁ to 14_{M} (to 14₄ in the figure) are arranged in parallel, so as to form right angles with the display electrodes 19a₁ to 19a_{N} and 19b₁ to 19b_{N} across the discharge space, and these data electrodes are covered by an insulating layer 13. Areas defined by crossing of (a) the pairs of display electrodes 19a₁ to 19a_{N} and 19b₁ to 19b_{N} and (b) the data electrodes 14₁ to 14_{M} correspond to discharge cells. Various pulses including reset pulses, scan pulses, data pulses, sustain pulses, and erasing pulses are applied to these electrodes 19a₁ to 19a_{N}, 19b₁ to 19b_{N}, and 14₁ to 14_{M}, based for example on the driving waveform process shown in FIG. 4. Among the various pulses, sustain pulses cause sustain discharges to be generated within the discharge gas, e.g., a rare gas. The sustain discharges mainly contribute to light emission, i.e., the sustain discharges cause phosphors in the phosphor layers to emit light.

Unlike such conventional displays as CRTs (cathode-ray tubes), PDP devices with the above-described construction can have a larger screen without much increasing its thickness and weight. Unlike LCD (liquid crystal display) devices, PDP devices do not suffer from a limited viewing angle. In this respect, PDP devices are advantageous over conventional displays.

One typical method for driving such PDP devices is based on the intra-field time division gradation display technique, which is described in the transactions of the Institute of Electronics, Information and Communication Engineers, IT 72-45 (1973). According to this technique, one field of image is time divided into several subfields (eight subfields in FIG. 3) each employing the above driving waveform process. A different binary weight is assigned to the sustain period of each subfield in such a manner that the relative luminance ratio for the several subfields gradually increases. For example, binary weights of 1, 2, 4, 8, 16, 32, . . . , 2ⁿ⁻¹ (n denotes the number of subfields) are respectively assigned to the subfields. Those subfields within one field are combined and images of the combined subfields are time-integrated on the eyes of the observer. In this way, linear gradation characteristics of, for example, 64 gradations in a case where n=6, and 256 gradations in a case where n=8 in FIG. 3, are realized.

FIG. 4 shows an example of a timing chart of the driving waveform process according to the intra-field time division gradation display technique (disclosed in detail in Japanese Laid-open Patent Application No. H4-195188). The driving waveform process shown in FIG. 4 is made up of a reset period, an address period, a sustain period, and an erasing period. During the reset period, the data electrodes 14₁ to 14_{M} and the sustain electrodes 19b₁ to 19b_{N} are grounded, and reset pulses are applied to all the scan electrodes 19a₁ to 19a_{N} so as to reset wall charges in discharge cells. During the address period, the discharge cells are successively scanned line by line, so that each of the discharge cells is given binary data of either ON or OFF. To be more specific, data pulses and scan pulses are respectively applied to data electrodes 14₁ to 14_{M} and sustain electrodes 19a₁ to 19a_{N} that are selected based on the image data, so as to accumulate wall charges in discharge cells to be lit. During the sustain period, sustain pulses are applied to all the display electrodes 19a₁ to 19a_{N} and 19b₁ to 19b_{N} in such a manner that their polarities become alternate. This causes discharges in the discharge cells where wall charges have been accumulated. The discharges cause emission of ultraviolet light, which excites the phosphor layers 16 to emit light. Here, the voltage of sustain pulses is normally set within a range of 150 to 200V, for the purpose of causing discharges only in the discharge cells where wall charges have been accumulated but not in other discharge cells.

In typical alternating-current (AC) PDP devices, a capacitor with a relatively high capacitance (hereafter referred to as a “panel capacitance”) is formed in an area of the dielectric layer 17 corresponding to a space between adjacent pairs of display electrodes 19a₁ to 19a_{N} and 19b₁ to 19b_{N} because adjacent display electrodes in different pairs have opposite polarities. Therefore, driving voltages applied to freely-chosen pairs of display electrodes 19a₁ to 19a_{N} and 19b₁ to 19b_{N} simply cause traveling of electric charges between each capacitor formed and its power source, thereby charging and discharging the dielectric layer 17 without consuming actual loads. This is represented by reactive power, meaning a loss. Such a loss due to reactive power tends to increase as the number of lines to be scanned, i.e., the number of pairs of display electrodes 19a₁ to 19a_{N} and 19b₁ to 19b_{N}, increases for the purpose of enabling the PDP unit 10 to feature a higher definition. Also, the panel capacitance increases as an area occupied by the pairs of display electrodes 19a₁ to 19a_{N} and 19b₁ to 19b_{N} increases for the purpose of expanding the size of the PDP unit 10. In view of reducing power consumption in PDP devices, therefore, such reactive power as described above is not preferable.

One technique for reducing such reactive power is to arrange the display electrodes 19a₁ to 19a_{N} and 19b₁ to 19b_{N} in such a manner that adjacent electrodes have the same polarity (specifically, electrodes are arranged in the order of a scan electrode, a sustain electrode, a sustain electrode, a scan electrode, . . . from the screen top to the screen bottom), to prevent a panel capacitance from being formed between adjacent ones of display electrodes 19a₁ to 19a_{N} and 19b₁ to 19b_{N}. With this technique, reactive power can be reduced, and accordingly, power consumption can be reduced. Hereafter, this arrangement order of display electrodes is referred to as the “ABBA order”, and the arrangement order in which scan electrodes 19a₁ to 19a_{N} and sustain electrodes 19b₁ to 19b_{N} are alternately arranged is referred to as the “ABAB order”. The PDP device in which the display electrodes 19a₁ to 19a_{N} and 19b₁ to 19b_{N} are arranged in the ABBA order can reduce reactive power by about 20 to 30% compared with PDP devices in which the display electrodes 19a₁ to 19a_{N} and 19b₁ to 19b_{N} are arranged in the ABAB order. This electrode arrangement in the ABBA order is an effective means for reducing reactive power that is expected to increase due to an increase in the number of scan lines for the purpose of enabling PDP devices to feature a higher definition, and due to an increase in the capacity of PDP units for the purpose of enabling PDP devices to have a larger screen.

High-definition PDP devices have a larger number of scan lines. With its address period being unchanged, therefore, a scan period corresponding to one scan electrode is shorter and a scan pulse width is shorter in such PDP devices. Erroneous address discharge may occur in such PDP devices. If erroneous address discharge occurs, discharge cells to be OFF may be lit and viewed as luminescent points, or discharge cells to be ON may not be lit and not viewed as luminescent points, thereby remarkably degrading display performances of the PDP devices.

Such erroneous address discharge frequently occurs when the display electrodes 19a₁ to 19a_{N} and 19b₁ to 19b_{N} are arranged in the ABBA order. Also, such erroneous address discharge frequently occurs at upper and lower screen edges of the PDP unit 10. To realize high quality image display, solutions to these problems are desperately called for.

### DISCLOSURE OF THE INVENTION

In view of the above problems, the present invention aims to provide a PDP device in which display electrodes are arranged in the ABBA order, that can reduce such power as reactive power thereby reducing its power consumption, and that can ensure correct address discharge thereby exhibiting favorable display performances.

The above aim of the present invention can be achieved by a driving method for a plasma display panel device that includes a plasma display panel unit and a driving unit, the plasma display panel unit including first display-electrode pairs and second display-electrode pairs that are alternately arranged in parallel, each first display-electrode pair being a scan electrode and a sustain electrode arranged in a first order and each second display-electrode pair being a scan electrode and a sustain electrode arranged in a second order opposite to the first order, thereby scan electrodes in adjacent first and second display-electrode pairs are adjacent to each other and sustain electrodes in adjacent first and second display-electrode pairs are adjacent to each other, the driving unit driving the plasma display panel unit based on an intra-field time division gradation display technique, the driving method including: a first step of applying, during an address period at a time of driving, a scan pulse to a plurality of scan electrodes selected from the first display-electrode pairs, sequentially in a direction based on the first order; and a second step of applying, during the address period, a scan pulse to a plurality of scan electrodes selected from the second display-electrode pairs, sequentially in a direction based on the second order.

With this method, PDP devices in which display-electrode pairs are arranged in the ABBA order can have priming particles, attributable to electrons of address discharge or ions of rare gas, always flow in the same direction toward adjacent display electrode pairs. To be more specific, scan pluses are applied in such a manner that scan electrodes have negative polarity and sustain electrodes have positive polarity, i.e., scan electrodes and sustain electrodes have opposite polarities. Due to this, electrons of address discharge flow in the same direction, i.e., in the direction based on the first order, or in the direction based on the second order, and the flow of electrons is accelerated. At the same time, the flow of priming particles is strongly accelerated by adjacent sustain electrodes with the same polarity. Therefore, a large amount of priming particles advantageous in starting discharge flow into one discharge cell after another in the address scanning direction. By performing such address scanning back and forth between the screen edges, erroneous address discharge can be prevented from occurring in the entire panel, thereby realizing favorable image display performances.

Also, in the first step, a scan pulse may be applied to all scan electrodes included in the first display-electrode pairs, sequentially in the direction based on the first order, and in the second step, a scan pulse may be applied to all scan electrodes included in the second display-electrode pairs, sequentially in the direction based on the second order, firstly from a scan electrode that is included in a second display-electrode pair and that is adjacent to a sustain electrode to which a scan pulse was lastly applied in the first step.

During the sustain period at the time of driving, sustain pulses may be applied to display-electrode pairs other than a display-electrode pair including a sustain electrode to which a sustain pulse is firstly applied during the address period in the first step. In some cases, an amount of priming particles in the vicinity of a display electrode for starting address discharge is relatively small at an early stage of the driving. In view of this, the display-electrode pair for starting address discharge may be used as a dummy display-electrode pair, and the other display-electrode pairs may be used as display-electrode pairs in the image display area of the panel. By doing so, display performances can be improved further.

The above aim of the present invention can also be achieved by a plasma display panel device comprising a plasma display panel unit and a driving unit, the plasma display panel unit including first display-electrode pairs and second display-electrode pairs that are alternately arranged in parallel, each first display-electrode pair being a scan electrode and a sustain electrode arranged in a first order and each second display-electrode pair being a scan electrode and a sustain electrode arranged in a second order opposite to the first order, thereby scan electrodes in adjacent first and second display-electrode pairs are adjacent to each other and sustain electrodes in adjacent first and second display-electrode pairs are adjacent to each other, the driving unit driving the plasma display panel unit based on an intra-field time division gradation display technique, wherein in an address period at a time of driving, the driving unit executes a first step of applying a scan pulse to a plurality of scan electrodes selected from the first display-electrode pairs sequentially in a direction based on the first order, and a second step of applying a scan pulse to a plurality of scan electrodes selected from the second display-electrode pairs sequentially in a direction based on the second order.

According to the PDP device with this construction, the above driving method of the present invention can be realized.

The scan electrodes or the sustain electrodes may have an electrode construction including a transparent electrode. The scan electrodes or the sustain electrodes may have an electrode construction including a fence electrode composed of a plurality of metal lines. Particularly when the fence electrode construction is employed, the effects can be produced of reducing the line resistance of electrodes and improving the luminous efficiency.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a partial perspective view showing the construction of a PDP unit;

FIG. 2 shows a matrix of display electrodes and data electrodes included in the PDP unit;

FIG. 3 shows a method for dividing a field at the time of driving a PDP device;

FIG. 4 is a timing chart of a driving waveform process showing the construction of a subfield;

FIG. 5 is a block diagram showing the construction of the PDP device;

FIG. 6 is a block diagram showing the construction of a scan driver;

FIG. 7 is a block diagram showing the construction of a data driver;

FIG. 8 is a timing chart of pulses for address discharge in a first embodiment of the present invention;

FIG. 9 shows a scanning order at the time of address discharge in the first embodiment;

FIG. 10 shows a flow of electrons (priming particles) at the time of address discharge in the first embodiment;

FIG. 11 shows a scanning order at the time of address discharge in the first embodiment (variation);

FIG. 12 shows a matrix of display electrodes and data electrodes in the first embodiment (variation);

FIG. 13 is a timing chart of pulses for conventional address discharge;

FIG. 14 shows a scanning order at the time of address discharge for conventional display electrodes arranged in the ABBA order;

FIG. 15 shows a flow of priming particles at the time of conventional address discharge;

FIG. 16 shows a scanning order at the time of address discharge for conventional display electrodes arranged in the ABAB order;

FIG. 17 shows how erroneous discharge easily occurs in image display in the direction reverse to the addressing direction; and

FIG. 18 is a block diagram showing the construction of a scan driver (variation).

### BEST MODE FOR CARRYING OUT THE INVENTION

1. Construction of the PDP Device in the First Embodiment

1-1. Construction of the PDP Unit

The following first describes an overall construction of a PDP device relating to a first embodiment of the present invention.

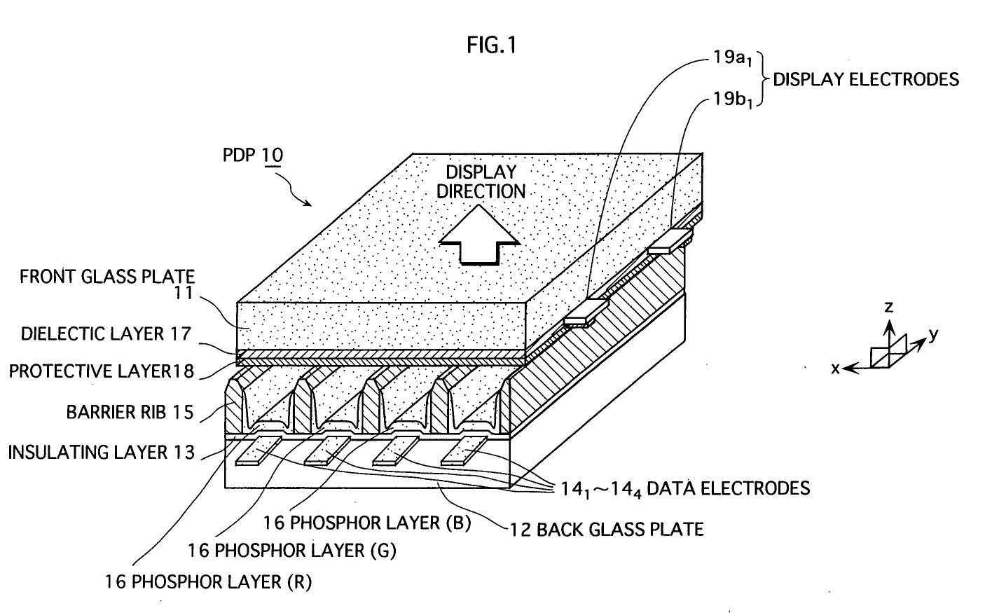

This PDP device includes a PDP unit 10 of an alternating-current (AC) surface discharge type, and a PDP driving unit 100 for driving the PDP unit 10. FIG. 1 is a partial perspective view of the PDP unit 10.

The PDP unit 10 includes a front glass plate 11 and a back glass plate 12 that are placed so as to face each other with a space formed between them, and are sealed at their peripheral portions.

On the surface of the front glass plate 11 facing the back glass plate 12, a scan electrode group composed of stripe scan electrodes 19a₁ to 19a_{N} and a sustain electrode group composed of sustain electrodes 19b₁ to 19b_{N}, where N is an integer (only a scan electrode 19a₁ and a sustain electrode 19b₁ are shown in FIG. 1) are formed in such a manner that scan electrodes and sustain electrodes are arranged in the ABBA order and electrodes of the same type (with the same polarity at the time of driving) are adjacent to one another, for example, in the order of electrodes 19a₁, 19b₁, 19b₂, 19a₂, . . . .

Here, the order of a scan electrode and a sustain electrode arranged in y-direction is referred to as a first order, and the order of a sustain electrode and a scan electrode arranged in y-direction is referred to as a second order. Further, a group of display electrodes arranged in the first order is referred to as a first group, and a group of display electrodes arranged in the second order is referred to as a second group.

The scan electrodes 19a₁ to 19a_{N} and the sustain electrodes 19b₁ to 19b_{N} are each made by forming a belt-shaped transparent electrode on the front glass plate 11 and forming a metal bus line on the transparent electrode.

The electrodes 19a₁ to 19a_{N} and 19b₁ to 19b_{N} are covered by a dielectric layer 17 made of lead glass or the like, and the surface of the dielectric layer 17 is covered by a protective layer 18 that is an MgO film or the like. On the surface of the back glass plate 12 facing the front glass plate 11, a group of stripe data electrodes 14₁ to 14_{M} is formed and an insulating layer 13 made of lead glass is provided to cover the group of data electrodes. On the insulating layer 13, barrier ribs 15 are arranged in parallel with the data electrodes 14₁ to 14_{M}. A space between the front glass plate 11 and the back glass plate 12 is divided at intervals of about 100 to 200 μm by the barrier ribs 15. A discharge gas is enclosed in the space between the front glass plate 11 and the back glass plate 12. The pressure at which the discharge gas is enclosed is set in such a manner that the pressure inside the panel becomes a negative pressure with respect to the pressure outside the panel (i.e., atmospheric pressure). The gas enclosure pressure is specifically set in a range of 100 to 500 Torr (1*10⁴ to 7*10⁴ Pa). In view of achieving high luminous efficiency, it is preferable to set the gas enclosure pressure as high as 8*10⁴ Pa, or higher.

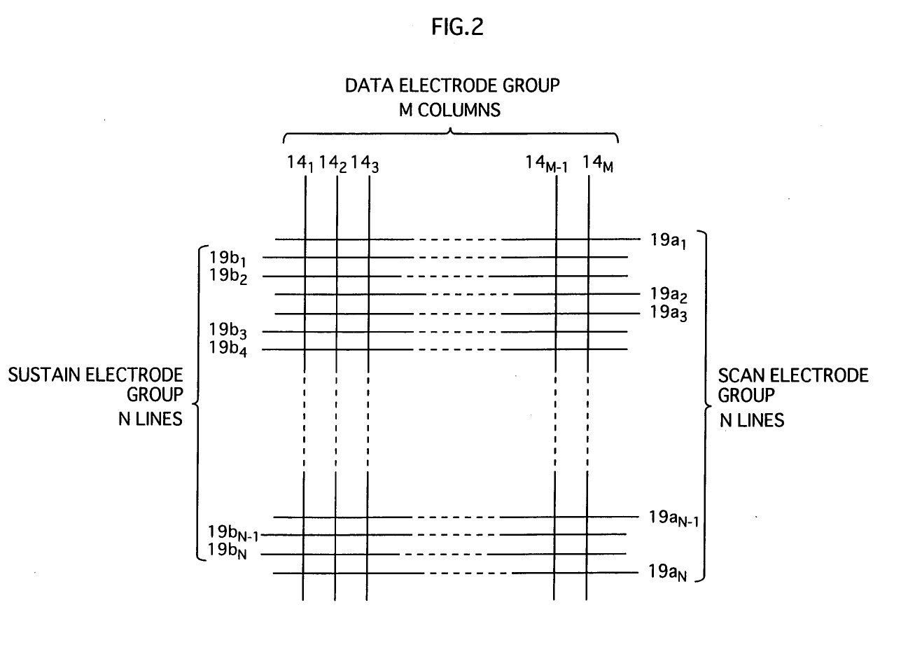

FIG. 2 shows a matrix of electrodes in this PDP unit 10. The display electrodes 19a₁ to 19a_{N} and 19b₁ to 19b_{N} and the data electrodes 14₁ to 14_{M} are arranged at right angles. In the space formed between the front glass plate 11 and the back glass plate 12, areas defined by crossing of the pairs of display electrodes 19a₁ to 19b₁, . . . , 19a_{N} to 19b_{N}, and the data electrodes 14₁ to 14_{M} correspond to discharge cells. Discharge cells are divided by the barrier ribs 15 in x-direction, thereby preventing discharge diffusion between adjacent discharge cells. Due to this, image display with high resolution is realized.

One example of WVGA panels may employ a discharge cell pitch of 360 μm in x-direction (longitudinal direction of the display electrodes 19a₁ to 19a_{N} and 19b₁ to 19b_{N}, a discharge cell pitch of 1080 μm in y-direction (longitudinal direction of the data electrodes 14₁ to 14_{N}), a width of the display electrodes 19a₁ to 19a_{N} and 19b₁ to 19b_{N} of 320 μm, and a discharge gap of display electrodes 19a₁ to 19a_{N} and 19b₁ to 19b_{N} of 80 μm, and a distance from scan electrodes 19a₁ to 19a_{N} (or sustain electrodes 19b₁ to 19b_{N}) to neighboring discharge cells of 180 μm. The present invention of course should not be limited to this panel specification.

The PDP unit 10 for monochrome display employs a mixed gas mainly composed of Ne as a discharge gas, and displays images by light emission in a visible area at the time of discharge. In the case of the PDP unit 10 for color display as shown in FIG. 1, the phosphor layers 16 of red (R), green (G), and blue (B) are formed on the inner walls of discharge cells, a mixed gas mainly composed of Xe (e.g., Ne—Xe gas and He—Xe gas) as a discharge gas, and ultraviolet light generated along with discharge is converted into visible light of the three colors, to realize color display.

This PDP unit 10 is driven basically using the intra-field time-division gradation display technique (ADS method; Address Display period Separated sub-field method).

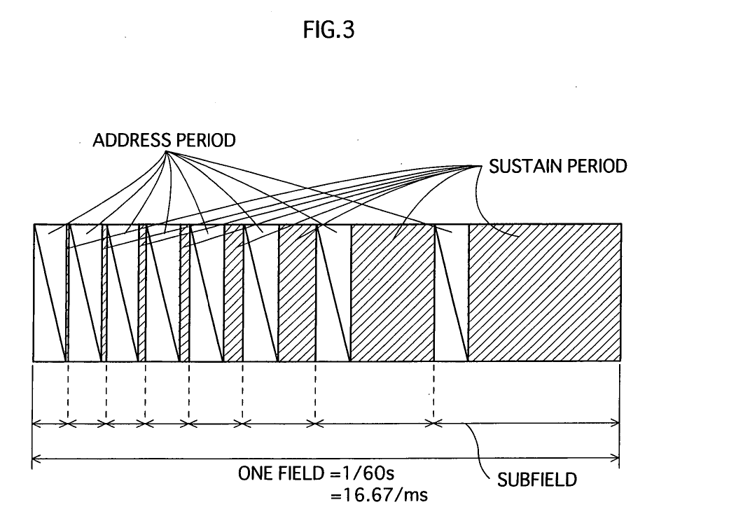

FIG. 3 shows a method for dividing one field using the intra-field time division gradation display technique expressing 256 gradations. In the figure, the horizontal direction indicates time. Among the divided areas, areas without diagonal lines represent address periods, and areas with diagonal lines represent sustain periods. The differing size of each area indicates the differing length of the corresponding period. Although not shown in the figure, a reset period is provided before the first address period, and an erasing period is provided after the last sustain period.

In the case of FIG. 3, one field is composed of eight subfields. Ratios of the sustain periods in the eight subfields are respectively set at 1, 2, 4, 8, 16, 32, 64, and 128. By combinations of these 8-bit binary numbers, 256 gradations can be expressed. For NTSC televisions, an image per second is composed of 60 fields, and therefore, one filed has 16.7 ms. Each subfield is composed of a sequence of a reset period, an address period, a sustain period, and an erasing period.

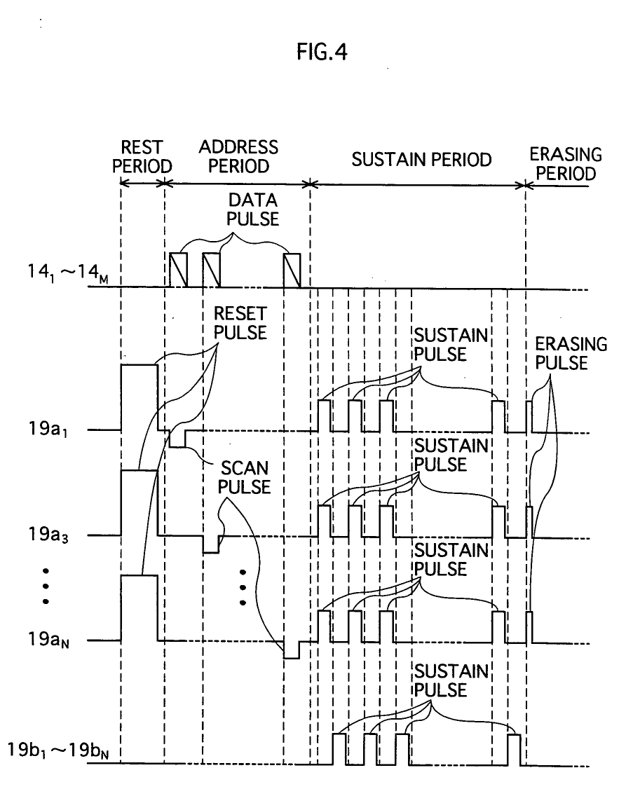

FIG. 4 is a timing chart of pulses applied to the electrodes in one subfield in the present embodiment.

During the reset period, reset pulses are applied at once to all the scan electrodes 19a₁ to 19a_{N}, so as to reset wall charges in all the discharge cells. The reset pulses here may take a rectangular waveform, or a ramp waveform with a gentle slope-up and a gentle slope-down.

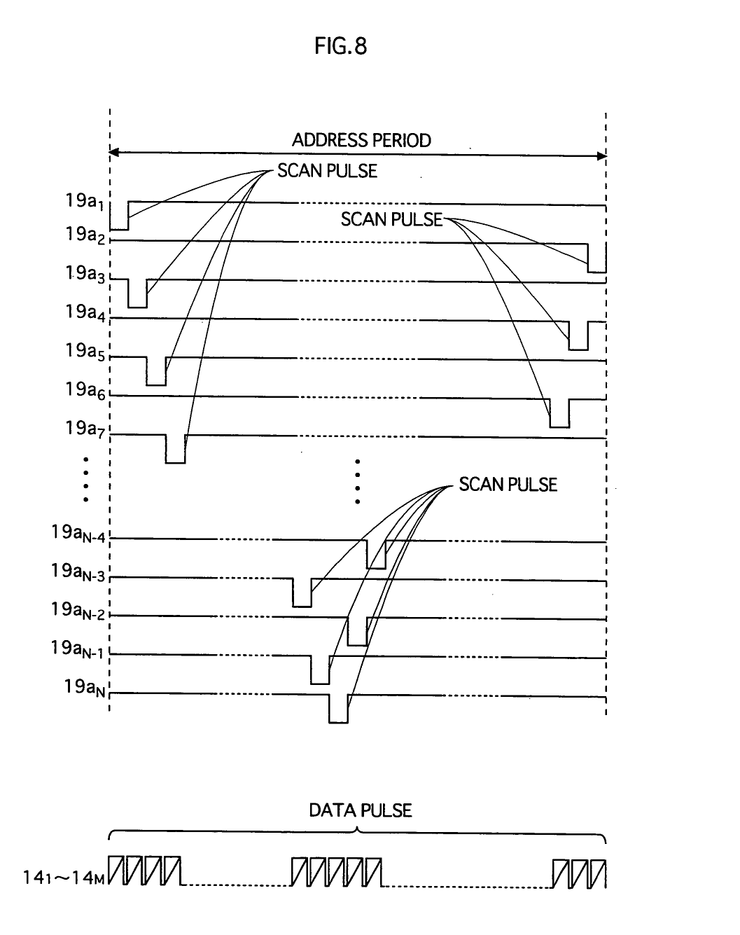

Here, the address period following the reset period is a main characteristic of the first embodiment. In the first embodiment, scan pulses are sequentially applied to the scan electrodes 19a₁ to 19a_{N} in a manner shown in the timing chart for the address discharge in FIG. 8. To be specific, scan pulses (address pulses) with negative polarity are first applied to scan electrodes in the first group of display electrodes, i.e., to the scan electrodes with subscripts of odd numbers 19a₁, 19a₃, 19a₅, 19a₇, . . . 19a_{N-3}, and 19a_{N-1}, sequentially from the screen top to the screen bottom in y-direction shown FIG. 1 (the direction perpendicular to the longitudinal direction of the display electrodes 19a₁, 19b₁, . . . ). When the application of scan pulses to the scan electrodes with subscripts of odd numbers to 19a_{N-1} is completed, scan pulses are then applied to scan electrodes in the second group of display electrodes, i.e., to the scan electrodes with subscripts of even numbers 19a_{N}, 19a_{N-2}, . . . 19a₈, 19a₆, 19a₄ and 19a₂, sequentially in the reverse direction, i.e., from the screen bottom to the screen top in y-direction shown in FIG. 1. As the screen of the PDP unit 10 is entirely viewed, the scan electrodes 19a₁ to 19a_{N} are sequentially scanned by applying scan pulses thereto in the scanning direction with every other scan electrode being skipped (skip scanning), and the scanning direction is reversed at the upper and lower edges of the screen.

During the address period, data pulses are applied to selected ones of the data electrodes 14₁ to 14_{M} corresponding to input image data, while the scan pulses are being applied to the scan electrodes. This causes wall charges to be accumulated in discharge cells to be lit, generating address discharge therein and causing electrons to charge the discharge cells to be lit. This results in writing of image information corresponding to one screen.

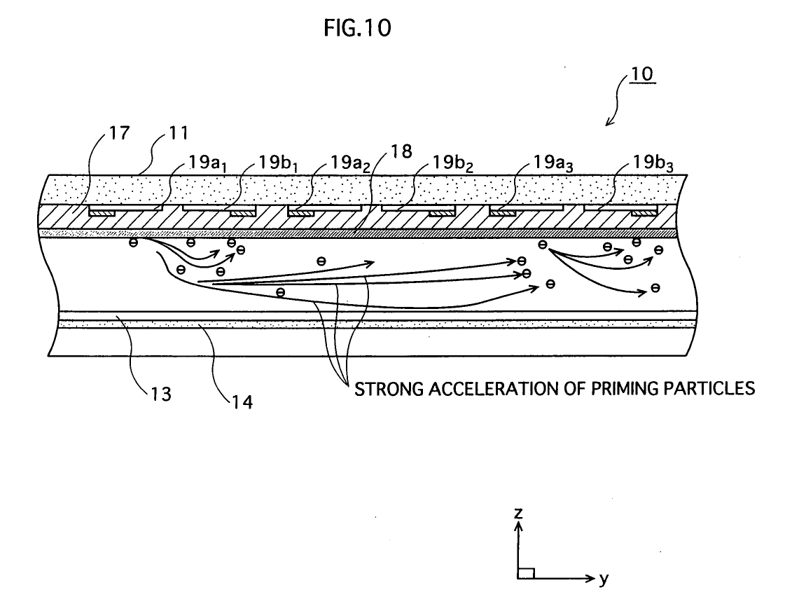

This driving process during the address period produces the following effects in the first embodiment. Pulses are applied to the scan electrodes 19a₁ to 19a_{N} with every other scan electrode being skipped (the rising timing of scan pulses to the scan electrodes is shifted with every other scan electrode being skipped). By doing so, a scan electrode (e.g., the scan electrode 19a₁) to which a scan pulse with negative polarity is currently applied shows negative polarity with respect to a sustain electrode (e.g., the sustain electrode 19b₁), and an electric potential of a scan electrode (19a₂) that is adjacent to the current scan electrode in the address scanning direction enters into the ground voltage state. Then, an address discharge is generated, and priming particles (positive ions of electrons, rare gases, and the like, positive ions of electrons are exemplified here) are generated within a corresponding discharge cell, thereby completing the discharge and addressing of the sustain electrode (e.g., 19b₁). Here, electrons generated in the vicinity of the scan electrode (e.g., 19a₁) are strongly attracted in the address scanning direction by two sustain electrodes with positive polarity (e.g., 19b₁ and 19b₂) positioned adjacent to a next scan electrode (e.g., 19a₂) as shown in a partial cross section taken along y-z plane in FIG. 10. In this way, a large amount of electrons flow into discharge cells to be lit one after another, as priming particles advantageous in starting discharge (in FIG. 10, both scan electrodes 19a₁ and 19a₃ are shown to have negative polarity for ease of explanation). By setting the scanning direction during the address period as the direction from a scan electrode with negative polarity to a sustain electrode with positive polarity at the time of address discharge, priming particles can flow into one discharge cell after another where address discharge is to be generated. As a result of this phenomenon, erroneous address discharge is prevented, and correct address discharge is ensured. This characteristic and the effects produced by this characteristic are described in detail later.

During the sustain period, sustain pulses are applied at once between the scan electrodes 19a₁ to 19a_{N} and the sustain electrodes 19b₁ to 19b_{N}, in such a manner that their polarities become alternate. This causes discharges in the discharge cells where wall charges have been accumulated. The discharges cause emission of light for a predetermined period of time.

During the erasing period, erasing pulses with a short width are applied at once to the scan electrodes 19a₁ to 19a_{N} to erase wall charges in the discharge cells.

1-2. Construction of the PDP Driving Unit and the Driving Method

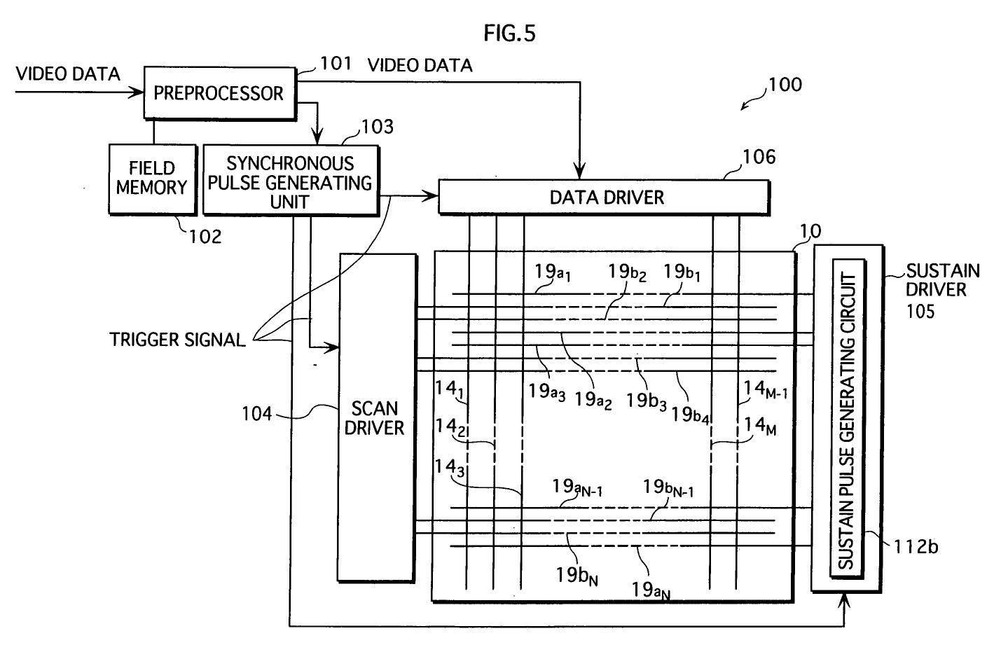

FIG. 5 is a block diagram showing the construction of the PDP driving unit 100. The PDP driving unit 100 employs a construction and a driving method substantially the same as conventional ones. However, the PDP driving unit 100 employs a method for applying a voltage to the scan electrodes 19a₁ to 19a_{N} during the address period at the time of driving, which is greatly different from conventional ones.

The PDP driving unit 100 includes a preprocessor 101, a field memory 102, a synchronous pulse generating unit 103, a scan driver 104, a sustain driver 105, and a data driver 106. The preprocessor 101 processes video data input from an external video outputting device. The field memory 102 stores the processed data. The synchronous pulse generating unit 103 generates a synchronous pulse for each subfield of each field. The scan driver 104 applies pulses to the scan electrodes 19a₁ to 19a_{N}. The sustain driver 105 applies pulses to the sustain electrodes 19b₁ to 19b_{N}. The data driver 106 applies pulses to the data electrodes 14₁ to 14_{M}.

The preprocessor 101 extracts video data corresponding to each field (each field of video data), from input video data, generates video data corresponding to each subfield (each subfield of video data), using the extracted field of video data, and stores the generated subfield of video data into the field memory 102. The preprocessor 101 may output data corresponding to one line from the current subfield of video data stored in the field memory 102, to the data driver 106. The preprocessor 101 may further detect synchronous signals such as a horizontal synchronous signal and a vertical synchronous signal, from input video data, and transmit the detected synchronous signals for each subfield of each field, to the synchronous pulse generating unit 103.

The field memory 102 can store video data for each field, in the form of video data divided for each of its subfields.

To be more specific, the field memory 102 is a two-port field memory having two memory areas each of which can store one field of image (typically eight or twelve subfields of image). The field memory 102 therefore can write a field of video data into one memory area while reading a field of video data from the other memory area.

The synchronous pulse generating unit 103 refers to a synchronous signal for each subfield of each field transmitted from the preprocessor 101, and generates a trigger signal indicating the rising timing of a reset pulse, a scan pulse, a sustain pulse, and an erasing pulse, and transmits the generated trigger signal to the drivers 104 to 106.

The scan driver 104 generates a reset pulse, a scan pulse, a sustain pulse, and an erasing pulse upon receipt of the trigger signal transmitted from the synchronous pulse generating unit 103, and applies the pulses to required ones of the scan electrodes 19a₁ to 19a_{N}.

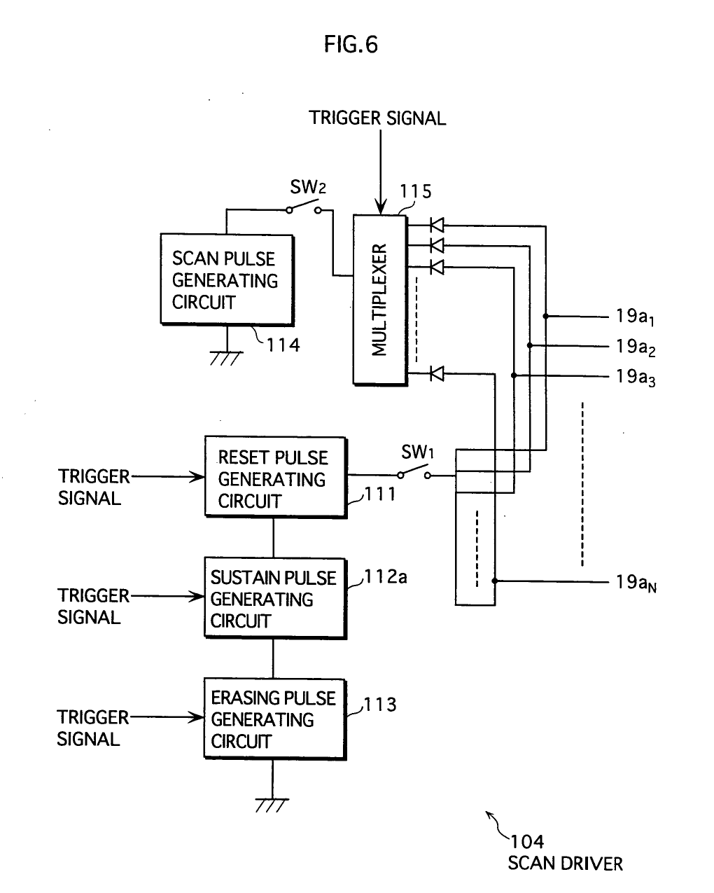

FIG. 6 is a block diagram showing the construction of the scan driver 104.

It should be noted here that a reset pulse, a sustain pulse, and an erasing pulse are commonly applied to all the scan electrodes 19a₁ to 19a_{N}.

As shown in FIG. 6, the scan driver 104 includes three pulse generating circuits (a reset pulse generating circuit 111, a sustain pulse generating circuit 112a, and an erasing pulse generating circuit 113) for respectively generating these three types of pulses. The three pulse generating circuits 111, 112a, and 113 are connected in series using a floating ground method. These pulse generating circuits 111, 112a, and 113 operate in accordance with trigger signals transmitted from the synchronous pulse generating unit 103, to selectively apply reset pulses, sustain pulses, and erasing pulses to the scan electrodes 19a₁ to 19a_{N}.

To apply scan pulses to the scan electrodes 19a₁, 19a₂, . . . , 19a_{N}, the scan driver 104 includes a scan pulse generating circuit 114 and a multiplexer 115 connected to the scan pulse generating circuit 114 as shown in FIG. 6. The multiplexer 115 is constructed by a commercially available LSI (e.g., ST7610). The multiplexer 115 applies, based on a program setting, scan pulses generated in the scan pulse generating circuit 114, to the scan electrodes 19a₁, 19a₂, . . . , 19a_{N}, according to a trigger signal input from the synchronous pulse generating unit 103. Here, the multiplexer 115 operates in accordance with the program setting realizing the following characteristic. Upon receipt of a trigger signal input from the synchronous pulse generating unit 103 at the time of driving, the multiplexer 115 sequentially applies scan pulses (address pulses) to scan electrodes in the first group of display electrodes, i.e., to the scan electrodes with subscripts of odd numbers 19a₁, 19a₃, 19a₅, 19a₇, . . . 19a_{N-3}, and 19a_{N-1}, sequentially in the direction from the screen top to the screen bottom, and then to scan electrodes in the second group of display electrodes, i.e., to the scan electrodes with subscripts of even numbers 19a_{N}, 19a_{N-2}, . . . 19a₈, 19a₆, 19a₄ and 19a₂, in the reverse direction, i.e., in the direction from the screen bottom to the screen top as shown in the timing chart for address discharge in FIG. 8.

The scan driver 104 further includes switches SW1 and SW2 for selectively applying outputs from the above three pulse generating circuits 111 to 113 and an output from the scan pulse generating circuit 114, to the scan electrodes 19a₁ to 19a_{N}.

The sustain driver 105 is internally equipped with a sustain pulse generating circuit 112b (not shown). The sustain driver 105 generates sustain pulses upon receipt of a trigger signal transmitted from the synchronous pulse generating unit 103, and applies sustain pulses to the sustain electrodes 19b₁ to 19b_{N}.

The data driver 106 outputs, in parallel, data pulses to the data electrodes 14₁ to 14_{M}, based on successively input subfield information corresponding to one line.

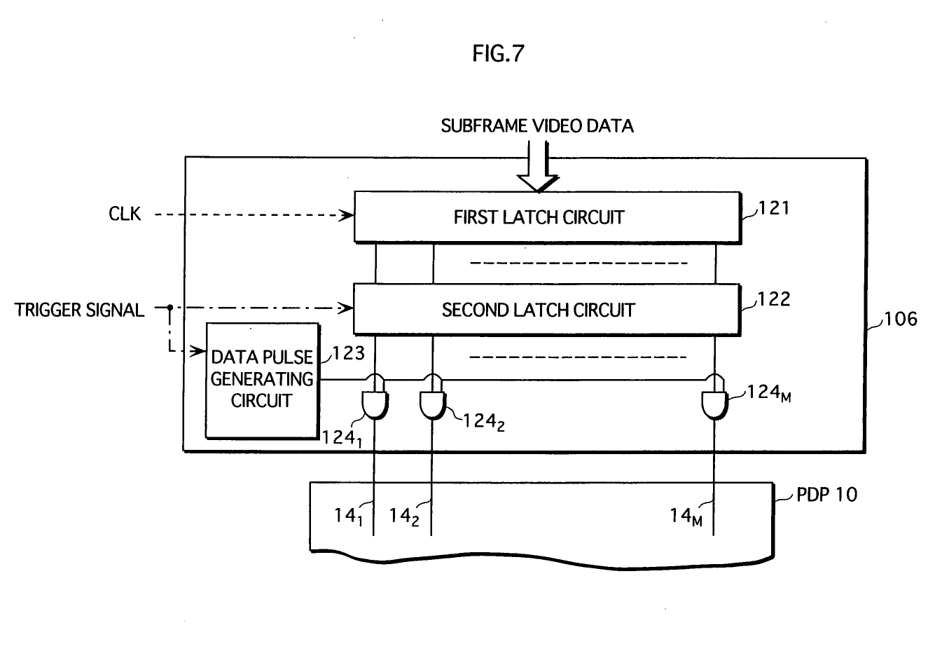

FIG. 7 is a block diagram showing the construction of the data driver 106.

The data driver 106 includes a first latch circuit 121, a second latch circuit 122, a data pulse generating circuit 123, and AND gates 124₁ to 124_{M}. The first latch circuit 121 latches, line by line, a subfield of video data. The second latch circuit 122 stores the latched subfield of video data. The data pulse generating circuit 123 generates a data pulse. The AND gates 124₁ to 124_{M} are provided at entries of the data electrodes 14₁ to 14_{M}.

The first latch circuit 121 latches, bits by bits, data from a subfield of video data that are sequentially transmitted from the preprocessor 101, in synchronization with a CLK signal. Upon latching one scan line of the subfield of video data (information indicating whether to apply a data pulse to each of the data electrodes 14₁ to 14_{M}), the first latch circuit 121 transfers at once the one scan line data to the second latch circuit 122. The second latch circuit 122 enables, among the AND gates 124₁ to 124_{M}, AND gates corresponding to data electrodes to which data pulses are to be applied among the data electrodes 14₁ to 14_{M}, according to a trigger signal transmitted from the synchronous pulse generating unit 103. Then, the data pulse generating circuit 12 generates a data pulse in synchronization with the trigger signal. Due to this, data pulses are applied to the data electrodes corresponding to the enabled AND gates among the data electrodes 14₁ to 14_{M}.

The following describes a method employed by the PDP driving unit 100 with the above-described construction for driving the PDP unit 10.

Basically, the PDP unit 10 is driven using the intra-field time division gradation display technique, and displays one field of image by repeating a plurality of times (typically, eight or twelve times) an operation for one subfield that is made up of a sequence of a rest period, an address period, a sustain period, and an erasing period.

During the reset period, the reset pulse generating circuit 111 applies reset pulses at once to all the scan electrodes 19a₁ to 19a_{N}, with the switch SW1 being ON and the switch SW2 being OFF in the scan driver 104, so that reset discharges are generated in all the discharge cells. By doing so, wall charges are accumulated in each discharge cell. By applying a certain level of wall voltage in each discharge cell in this way, the rising of address discharge in the following address period can be expedited.

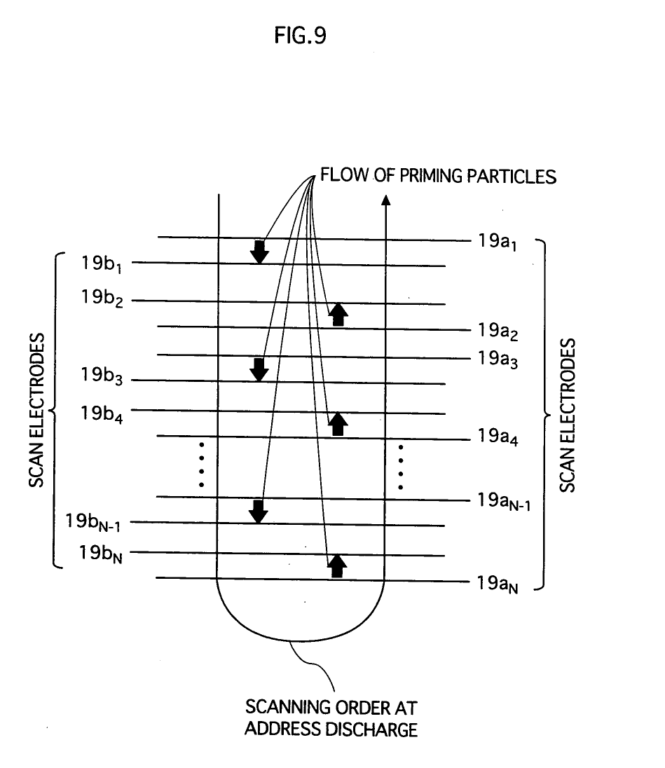

During the address period relating to the first embodiment, with the switch SW2 being ON and the switch SW1 being OFF in the scan driver 104, the multiplexer 115, which has been subjected to predetermined programming, applies scan pulses with negative polarity generated in the scan pulse generating circuit 114, to the scan electrodes with subscripts of odd numbers in the first group, i.e., the scan electrodes 19a₁, 19a₃, 19a₅, 19a₇, . . . , 19a_{N-3} and 19a_{N-1}, sequentially in the direction from the screen top to the screen bottom. When the application of scan pulses to the scan electrode with subscripts of odd numbers to 19a_{N-1} is completed, the multiplexer 115 then applies scan pulses to the scan electrodes with subscripts of even numbers in the second group, i.e., the scan electrodes 19a_{N}, 19a_{N-2}, . . . , 19a₈, 19a₆, 19a₄ and 19a₂, sequentially in the reverse direction, i.e., the direction from the screen bottom to the screen top. In synchronization with the application of scan pulses, the data driver 106 applies data pulses with positive polarity to data electrodes corresponding to discharge cells to be lit among the data electrodes 14₁ to 14_{M}. In this way, scan pulses are applied to all the scan electrodes 19a₁ to 19a_{N}, and data pulses are applied to the corresponding data electrodes, so that address discharges are generated in the discharge cells to be lit, and wall charges are accumulated in the discharge cells to be lit. As a result, an image corresponding to the screen of the PDP unit 10 is written. According to the first embodiment, for the PDP unit 10 in which the pairs of display electrodes 19a₁ and 19b₁ to 19a_{N} and 19b_{N} are arranged in the ABBA order, address scanning is performed in such a manner that scan pulses are sequentially applied to scan electrodes, with every other one of the scan electrodes 19a₁ to 19a_{N} being skipped, so that address discharges are generated. By doing so, among the pairs of display electrodes 19a₁ and 19b₁ to 19a_{N} and 19b_{N}, pairs of display electrodes including the scan electrodes to which scan electrodes have been applied, can have priming particles, attributable to electrons of address discharges, flow in the same direction. FIG. 9 shows the scanning order at the time of address discharge. As shown in FIG. 9, a large amount of priming particles advantageous in starting discharge flow into discharge cells arranged in the direction based on the address scanning order (i.e., the direction based on back-and-forth scanning from the screen top to the screen bottom and from the screen bottom to the screen top in the first embodiment). Due to this, erroneous address discharge can be prevented, and correct address discharge can be ensured, thereby realizing favorable image display performances.

During the sustain period, with the switch SW1 being ON and the switch SW2 being OFF in the scan driver 104, applying fixed-width sustain pulses (e.g., 1 to 5 μsec wide) with positive polarity at once to the scan electrodes 19a₁ to 19a_{N} in the sustain pulse generating circuit 112a and applying fixed-width sustain pulses with positive polarity at once to the sustain electrodes 19b₁ to 19b_{N} in the sustain pulse generating circuit 112b of the sustain driver 105 are repeated, so that scan electrodes and sustain electrodes alternately have opposite polarities.

In discharge cells where wall charges have been accumulated during the address period, an electric potential at the surface of the dielectric layer 17 exceeds the discharge starting voltage, thereby starting discharge. Within these discharge cells, the sustain discharge causes ultraviolet light to be emitted. The emitted ultraviolet light is converted into visible light by the phosphor layers 16(R), (G), and (B), so that visible light of red, green, and blue corresponding to the phosphor layers 16(R), (G), and (B) is emitted.

During the erasing period, with the switch SW1 being ON and the switch SW2 being OFF in the scan driver 104, the erasing pulse generating circuit 113 applies erasing pulses with a short width at once to the scan electrodes 19a₁ to 19a_{N}, to generate incomplete discharge, thereby erasing wall charges in the discharge cells.

This completes driving of one subfield.

2. Specific Effects Produced at Driving in the First Embodiment

In typical AC (alternating-current) PDP devices, the dielectric layer 17 formed at the front glass plate 11 to cover the pairs of display electrodes 19a₁ to 19a_{N} and 19b₁ to 19b_{N} have, for its structural reasons, areas where a capacitor with a relatively large capacitance is formed. Such areas of the dielectric layer 17 correspond to not only spaces between adjacent electrodes in the same pairs of display electrodes 19a₁ to 19a_{N} and 19b₁ to 19b_{N} but also spaces between adjacent electrodes with opposite polarities in different pairs of display electrodes 19a₁ to 19a_{N} and 19b₁ to 19b_{N}. Therefore, driving voltages applied to freely-chosen pairs of display electrodes 19a₁ to 19a_{N} and 19b₁ to 19b_{N} simply cause traveling of electric charges in such areas, specifically between each capacitor formed and its power source, thereby charging and discharging the dielectric layer 17. This heat loss is represented by reactive power, meaning a loss.

Such a loss due to reactive power tends to increase as the number of lines to be scanned, i.e., the number of pairs of display electrodes 19a₁ to 19a_{N} and 19b₁ to 19b_{N}, increases for the purpose of enabling the PDP unit 10 to feature a higher definition. Also, the panel capacitance increases as an area occupied by the pairs of display electrodes 19a₁ to 19a_{N} and 19b₁ to 19b_{N} increases for the purpose of increasing the size of the PDP unit 10. In view of reducing power consumption in PDP devices, therefore, such reactive power is not preferable in enabling the PDP unit 10 to feature a higher definition and increasing the size of the PDP unit 10.

One technique for reducing the loss due to the reactive power is to arrange the display electrodes 19a₁ to 19a_{N} and 19b₁ to 19b_{N} in such a manner that adjacent electrodes have the same polarity at the time of driving (specifically, electrodes are arranged in the ABBA order, i.e, in the order of a scan electrode, a sustain electrode, a sustain electrode, and a scan electrode, . . . from the screen top to the screen bottom), to prevent a panel capacitance from being formed between adjacent ones of display electrodes 19a₁ to 19a_{N} and 19b₁ to 19b_{N}. With this technique, reactive power can be reduced, and accordingly, power consumption can be reduced.

The PDP device in which the display electrodes 19a₁ to 19a_{N} and 19b₁ to 19b_{N} are arranged in the ABBA order can reduce reactive power by about 20 to 30% compared with PDP devices in which the display electrodes 19a₁ to 19a_{N} and 19b₁ to 19b_{N} are arranged in the ABAB order. This electrode arrangement in the ABBA order is an effective means for reducing reactive power that is expected to increase due to an increase in the number of scan lines for the purpose of enabling PDP devices to feature a higher definition, and due to an increase in the capacity of PDP units for the purpose of enabling PDP devices to have a larger screen.

However, high-definition PDP devices have a larger number of scan lines. For such PDP devices, a scan pulse width is shorter during the address period, (e.g., a width being as short as about 1 μs for XGA panels, whereas a width being about 2 μs for WVGA panels). This may cause incomplete address discharge, resulting in erroneous address discharge. Such erroneous address discharge can be explained by the theory of probability that the discharge phenomenon grows an electron avalanche by applying voltages. Therefore, such erroneous address discharge appears to be caused by a reduced probability of generating discharge due to a shortened voltage application time period. If erroneous address discharge occurs, discharge cells to be OFF may be lit and viewed as luminescent points, or discharge cells to be ON may not be lit and not be viewed as luminescent points, thereby greatly degrading display performances of the PDP devices.

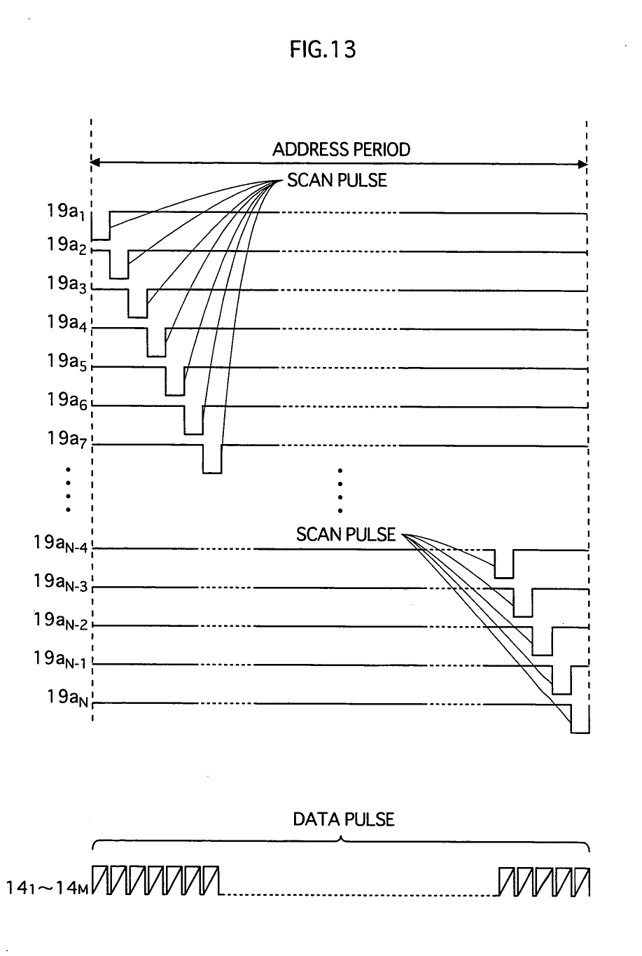

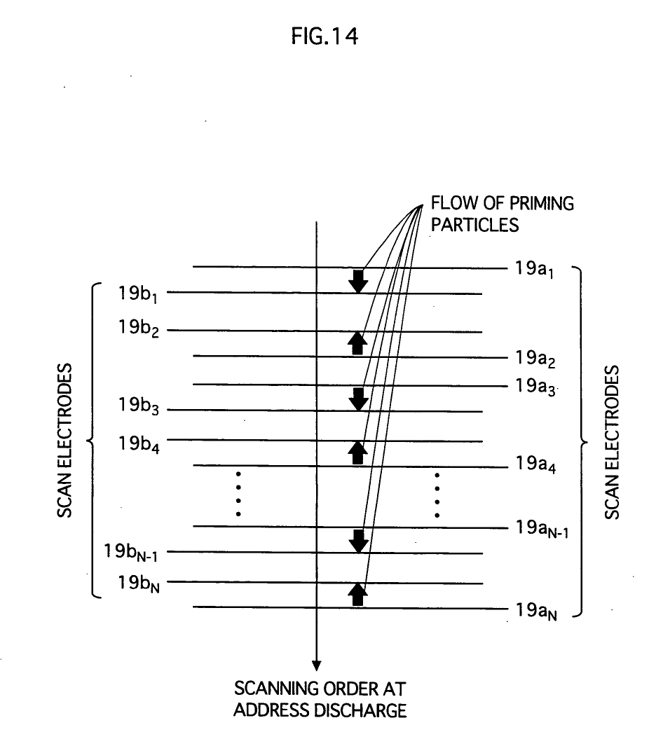

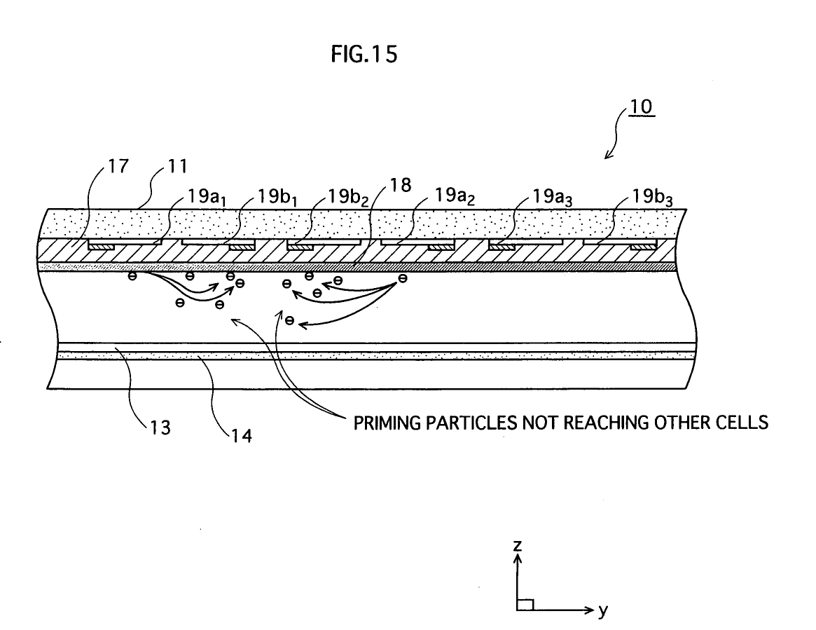

Such erroneous address discharge frequently occurs when the display electrodes 19b₁ to 19b_{N} and 19b₁ to 19b_{N} are arranged in the ABBA order. Also, such erroneous address discharge frequently occurs at upper and lower screen edges of the PDP unit 10. The inventors of the present application have discovered that one of the causes of such erroneous address discharge is a shortage of priming particles within discharge cells to be lit. To be specific, for conventional PDP devices in which display electrodes are arranged in the ABBA order, discharges are generated between the data electrodes 14₁ to 14_{M} and the scan electrodes 19a₁ and 19a_{N} sequentially from the screen top to the screen bottom and the discharges are utilized by the sustain electrodes 19b₁ and 19b_{N} to generate address discharges as shown in the timing chart for scan pulses during a conventional address period in FIG. 13. Therefore, electrons as priming particles generated between adjacent ones of the display electrodes 19a₁ to 19a_{N} and 19b₁ and 19b_{N} in the direction from the screen top to the screen bottom flow in opposite directions as shown in FIG. 14. These priming particles flowing in the opposite directions collide with each other. FIG. 15 is a partial cross section of a PDP unit taken along y-z plane, for specifically showing the flow of electrons as priming particles (In FIG. 15, both the scan electrodes 19a₁ to 19a₂ are shown to have negative polarity). As shown in FIG. 15, adjacent ones of the display electrodes 19a₁ to 19a_{N} and 19b₁ to 19b_{N} have priming particles flowing in opposite directions and colliding with each other. Therefore, a large amount of priming particles do not reach other discharge cells. In this case, erroneous address discharge easily occurs.

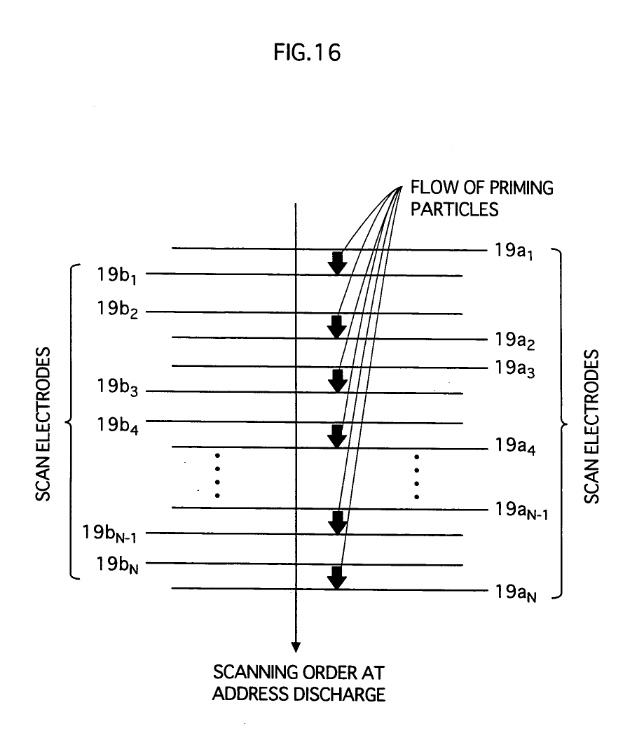

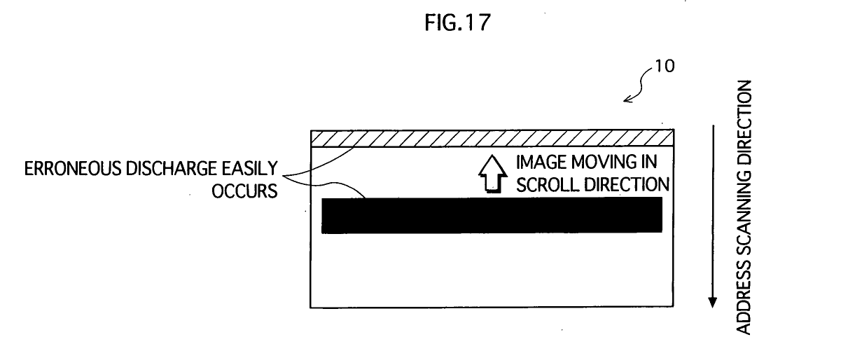

On the other hand, for conventional PDP devices in which display electrodes are arranged in the ABAB order, address discharges are generated between the data electrodes 14₁ to 14_{M} and the scan electrodes 19a₁ to 19a_{N} sequentially from the screen top to the screen bottom as shown in FIG. 16, generating electrons as priming particles flowing in the same direction. In this case, a certain amount of priming particles flow into other discharge cells in the address scanning direction (here, the direction from the screen top to the screen bottom). Therefore, erroneous address discharge can be prevented to a certain degree. A problem arises however, when a moving image to be scrolled in the direction reverse to the address scanning direction (here, y-direction from the screen bottom to the screen top) is to be displayed as shown in FIG. 17. A substantial amount of priming particles do not flow into discharge cells to be sequentially lit. In this case, erroneous address discharge may occur, which degrades the image display. This problem is particularly serious when a background of an image to be displayed is black and dark.

Further, for PDP devices in which the display electrodes are arranged in the ABBA order and in the ABAB order, a shortage of priming particles is particularly found in the vicinity of discharge cells for starting the address scanning (in the vicinity of the upper edge of the screen in the example of FIG. 17). Therefore, erroneous address discharge easily occurs in the vicinity of discharge cells for starting the address scanning.

To realize high-quality image display, solutions to the above-described problems are desperately called for.

In view of the above problems, the present invention provides a PDP device in which display electrodes 19a₁ to 19a_{N} and 19b₁ to 19b_{N} are arranged in the ABBA order, and that can prevent reactive power from being generated and ensure correct address discharge, thereby reducing power consumption and realizing favorable display performances. To be specific, the inventors made every effort to find the solutions, and have come up with the following method. During the address period at the time of driving of the PDP device, scan pulses (address pulses) are applied to the scan electrodes 19a₁ to 19a_{N} in the following way. Scan pulses are first applied to scan electrodes in the first group of display electrodes, i.e., to the scan electrodes with subscripts of odd numbers 19a₁, 19a₃, 19a₅, 19a₇, . . . 19a_{N-3} and 19a_{N-1}, sequentially from the screen top to the screen bottom in y-direction, and then to scan electrodes in the second group of display electrodes, i.e., to the scan electrodes with subscripts of even numbers 19a_{N}, 19a_{N-2}, . . . 19a₈, 19a₆, 19a₄ and 19a₂, sequentially in the reverse direction, i.e., from the screen bottom to the screen top in y-direction. In this way, the rising timing of scan pulses to the scan electrodes 19a₁ to 19a_{N} is shifted with every other scan electrode being skipped, and the scanning direction is reversed at the upper and lower edges of the screen.

In this way, the scan electrodes 19a₁ to 19a_{N} are sequentially scanned with every other one scan electrode being skipped, and address discharges are generated. By doing so, pairs of display electrodes including the scan electrodes 19a₁ to 19a_{N} to which scan pluses have been applied among the pairs of display electrodes 19a₁, 19b₁, . . . , 19a_{N}, 19b_{N} have priming particles, attributable to electrons of address discharge, flow in the same direction. At the same time, priming particles are strongly attracted by adjacent sustain electrodes 19b₁, 19b₂, . . . with positive polarity. As shown in the scanning order at the time of address discharge in FIG. 9, a large amount of priming particles advantageous in starting discharge flow into discharge cells arranged in the direction based on the address scanning order (i.e., the direction based on back-and-forth scanning from the screen top to the screen bottom and from the screen bottom to the screen top in the first embodiment). Due to this, erroneous address discharge can be prevented, and correct address discharge can be ensured with the use of priming particles as a starter for discharge, thereby realizing favorable image display performances.

The experiments conducted by the inventors confirm that WVGA panels employing a discharge cell pitch of 1.08 mm in y-direction exhibit a large amount of priming particles flowing into a discharge cell positioned four or five cells away from the current discharge cell, thereby producing the effect of stabilizing address discharge.

Although the experiments confirm that this priming particle effect is produced on adjacent cells in the direction where electrons are attracted, the experiments show that the priming particle effect is not produced on adjacent discharge cells in the direction where positive ions are attracted, which is opposite to the above direction where the electrons are attracted. This can be considered because the distance by which electrons move is generally larger by several digits than the distance by which positive ions move. Therefore, the priming particle effect is considered to be produced by flowing of priming particles to adjacent cells.

Accordingly, in such high-definition PDP devices as XGA panels employing a narrow discharge cell pitch in y-direction, priming particles flow into discharge cells that are distant from the current discharge cell in which address discharge is generated. Further, due to the display electrodes 19b₁, 19b₂, . . . 19b_{N}, 19b_{N} arranged in the ABBA order, reactive power can be reduced, and therefore, address discharge can be stabilized. Particularly in the first embodiment, a voltage required for address discharge can be reduced by utilizing priming particles. A voltage required for applying data pulses during the address period, which has conventionally been about 70V, can be reduced by about 5V.

As described above in the first embodiment, within each subfield, the scan electrodes 19a₁ to 19a₂ are sequentially scanned with every other scan electrode being skipped in such a manner that priming particles flow in the same direction, i.e., to the screen top or to the screen bottom, for the address discharge of the entire PDP unit 10. When the PDP device is driven as described above, therefore, there would be no such image display realized by scrolling in the direction reverse to the scanning direction of the address discharge where erroneous address discharge easily occurs. In the first embodiment, therefore, moving image display performances of the PDP unit 10 can be dramatically improved as compared with conventional cases.

3. Others

3-1. Polarity of Pulse

Although the first embodiment describes the case where negative polarity pulses are applied to the scan electrodes 19a₁ to 19a_{N}, the present invention should not be limited to such. With the driving method for applying positive polarity pulses to the scan electrodes 19a₁ to 19a_{N}, too, the effect of reducing delay of discharge can be produced by address scanning in the direction where electrons move in address discharge described above. In this case, however, negative polarity pulses are to be applied to the data electrodes 14₁ to 14_{M}, to provide an appropriate voltage difference. Here, the sustain electrodes 19b₁ to 19b_{N} have negative polarity opposite to the polarity of the scan electrodes 19a₁ to 19a_{N}. Further, it is known that a better effect, i.e., the effect of shortening the address discharge delay time “Ts”, can be produced when priming particles are electrons.

3-2. Variations of Address Scanning Method

The first embodiment describes the case where during the address period, scan pulses are first applied to scan electrodes in the first group of display electrodes, i.e., to the scan electrodes with subscripts of odd numbers 19a₁, . . . , 19a_{N-1}, sequentially from the screen top to the screen bottom and then to scan electrodes in the second group of display electrodes, i.e., to the scan electrodes with subscripts of even numbers 19a_{N}, . . . , 19a₂, sequentially in the reverse direction, i.e., from the screen bottom to the screen top. Here, there may be cases where an amount of priming particles is relatively small in the vicinity of the display electrode 19a₁ at which address discharge is started in the uppermost edge of the screen. In view of this, a pair of display electrodes 19a₁ and 19b₁ may be used as dummy display electrodes, and pairs of display electrodes 19a₂, 19b₂, . . . , 19a_{N}, 19b_{N} for which correct address discharge can be performed may be used as display electrodes in the image display area, and sustain discharge may be performed only on the pairs of display electrodes 19a₂, 19b₂, . . . , 19a_{N}, 19b_{N} for which correct address discharge can be performed. In this case, only an area where correct address discharge can be performed is used for image display, and therefore, display performances can be improved further. A specific method for realizing this is to use the multiplexer 115 and the switches SW1 and SW2, and to use the pairs of display electrodes 19a₂, 19b₂, . . . , 19a_{N}, 19b_{N}, and the group of data electrodes 14₁ to 14_{M} as driving electrodes corresponding to the image display area. Scan pulses are applied to the pair of display electrodes 19a₁ and 19b₁ within every field regardless of image information, and data pulses are applied to all the data electrodes 14₁ to 14_{M}, to generate address discharge. Due to this, priming particles can be filled in discharge cells corresponding to the pair of display electrode 19a₁ and 19b₁. As a result, correct address discharge can be performed in the discharge cells within the image display area of the panel.

Also, the first embodiment describes the case where address discharge is started from the scan electrode 19a₁ or 19a₂. However, the present invention should not be limited to such. Address discharge may be started from any of the other ones of the scan electrodes 19a₁ to 19a_{N}. In this case, however, the address scanning order in y-direction needs to be reversed at the upper and lower edges of the screen two times or more, so as to write image information corresponding to one screen.

Further, the scanning order reverse to the order employed in the first embodiment may be employed. To be specific, scan pulses may be applied to scan electrodes in the first group of display electrodes, i.e., to the scan electrodes with subscripts of odd numbers 19a₁, . . . , 19a_{N}, sequentially from the screen bottom to the screen top and then to scan electrodes in the second group of display electrodes, i.e., to the scan electrodes with subscripts of even numbers 19a₂, . . . , 19a_{N}, sequentially in the reverse direction, i.e., from the screen top to the screen bottom. In this case, too, there may be cases where an amount of priming particles is relatively small in the vicinity of the display electrode 19a_{N} at which address discharge is started in the bottommost edge of the screen. In view of this, a pair of display electrodes 19a_{N} and 19b_{N} may be used as dummy display electrodes, and pairs of display electrodes 19a₂, 19b₂, . . . , 19a_{N-1}, 19b_{N-1} may be used as display electrodes in the image display area. In this case, it is preferable to provide a black layer such as a black matrix between the front glass plate 11 and the dummy electrodes 19a_{N} and 19b_{N}. The black layer can reduce unnecessary light emission in areas other than the display area, and improve the visibility in the display area.

Further, the first embodiment describes the case where the address discharge is performed in the order of even numbers or odd numbers given to scan electrodes. The present invention should not be limited to such. For example, the address discharge may be performed in the order of values obtained by multiplying the even numbers given to scan electrodes by a multiple of two, or in the order of values obtained by multiplying the odd numbers given to scan electrodes by a multiple of one or three. In this case too, however, the address scanning order needs to be reversed at the upper and lower edges of the screen two times or more, so as to write image information corresponding to one screen.

The address scanning may be performed in the direction from the screen bottom to the screen top.

3-3. Variations of Display Electrodes

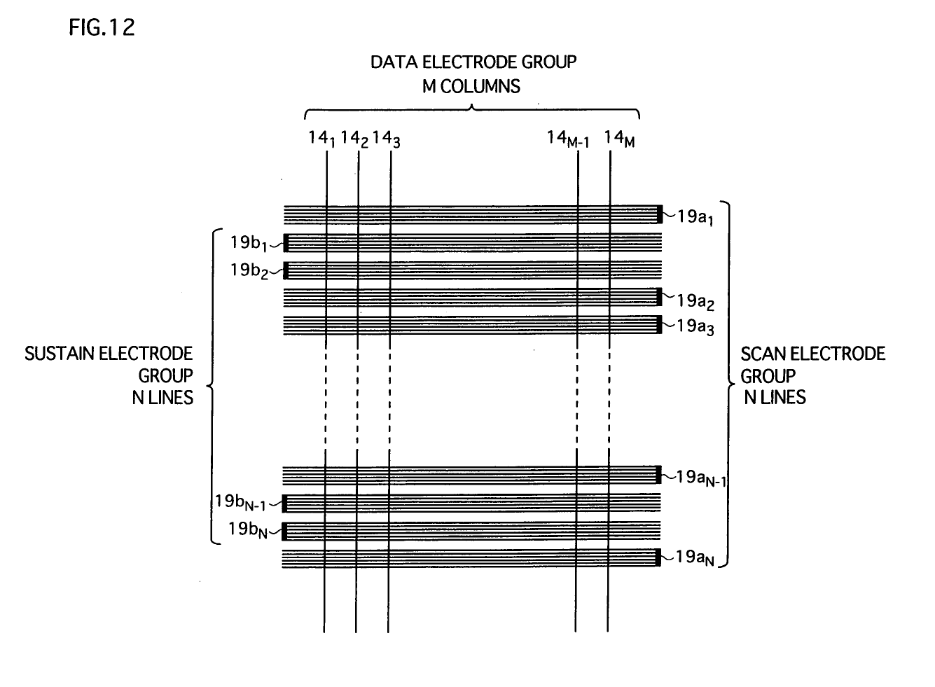

The first embodiment describes the case where the scan electrodes 19a₁ to 19a_{N} and the sustain electrodes 19b₁ to 19b_{N} are each made by forming a belt-shaped transparent electrode on the front glass plate 11 and forming a metal bus line on the transparent electrode. The present invention should not be limited to such. For example, each electrode may be made by only forming a metal bus line. Alternatively, as shown in an electrode matrix diagram of FIG. 12, an FE electrode (fence electrode) construction may be employed where fine metal lines constitute each of the scan electrodes 19a₁ to 19a_{N} and the sustain electrodes 19b₁ to 19b_{N}. Also, only the scan electrodes 19a₁ and 19a_{N} or the sustain electrodes 19b₁ to 19b_{N} may employ the fence electrode construction. By utilizing such metal electrodes, the line resistance of electrodes can be reduced, and a voltage drop caused by discharge current can be reduced. Therefore, actual driving voltages can be reduced further. This may produce a profound effect of improving the luminous efficiency, particularly now that the presently dominant 42-inch PDPs are expected to be replaced by 50-inch or 60-inch PDPs.

Silver, Cr—Cu—Cr, etc., may be used as a metal material for these electrodes.

3-4. Variations of Display Electrode Arrangement

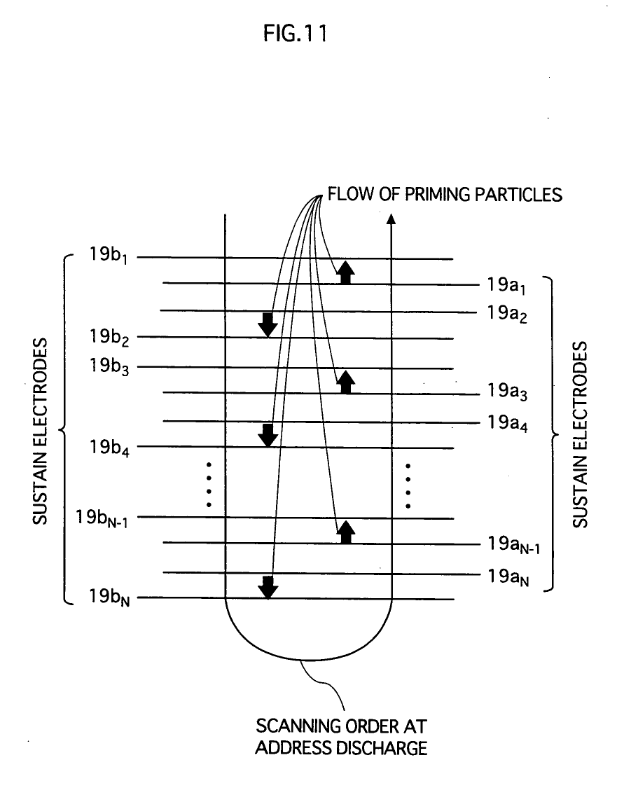

The first embodiment describes the case where the scan electrodes 19a₁ to 19a_{N} and the sustain electrodes 19b₁ to 19b_{N} are arranged in the order of 19a₁, 19b₁, . . . , from the screen top to the screen bottom. The present invention should not be limited to such. For example, as in FIG. 11 showing the scanning order at the time of address discharge, the scan electrodes 19a₁ to 19a_{N} and the sustain electrodes 19b₁ to 19b_{N} may be arranged in the order of 19b₁, 19a₁, . . . , from the screen top to the screen bottom. In this case, too, the same effects can be produced.

3-5. Variations of Driving Unit

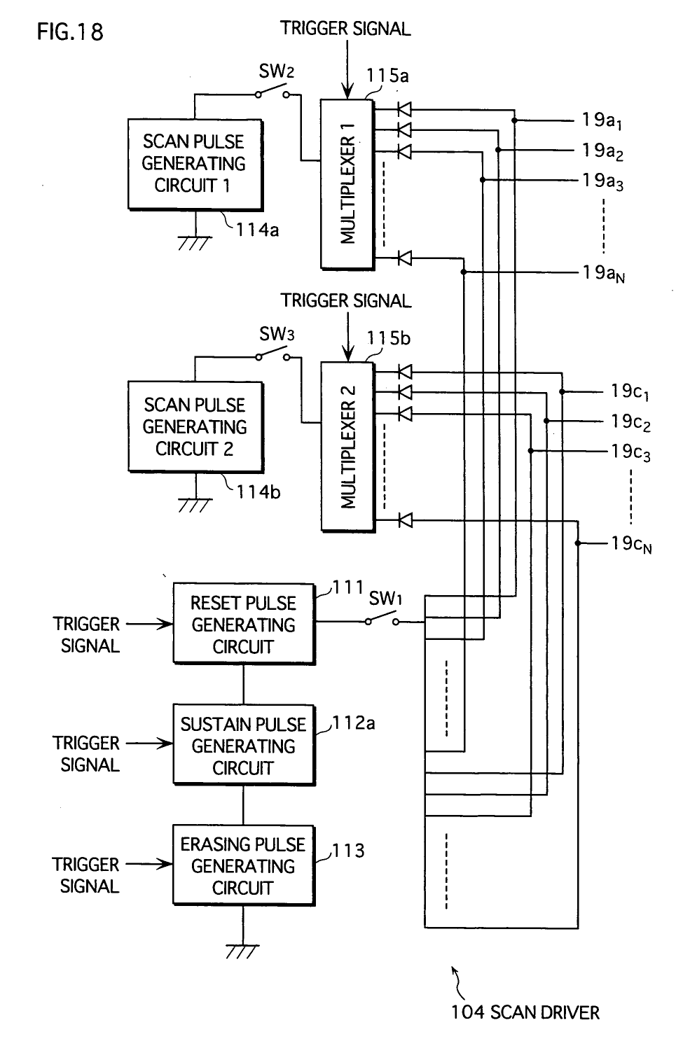

The first embodiment describes the case where so-called “single scan driving” is employed in which the scan electrodes 19a₁ to 19a_{N} in the entire PDP unit 10 are driven centrally by the scan driver 104. The present invention should not be limited to such. For example, as shown in the block diagram of the scan driver of FIG. 18, so-called “double scan driving” may be employed in which the group of scan electrodes 19a₁ to 19a_{N} is divided into two groups, i.e., the group of scan electrodes 19a₁ to 19a_{N} and the group of scan electrodes 19c₁ to 19c_{N} in the screen top-bottom direction, and the group of scan electrodes 19a₁ to 19a_{N} and the group of scan electrodes 19c₁ to 19c_{N} may be driven respectively by two independent systems, i.e., (1) a scan pulse generating circuit 1 (114a) and a multiplexer 1 (115a) and (2) a scan pulse generating circuits 2 (114b) and a multiplexer 2 (115b).

Further, although the first embodiment describes the case where a scan pulse is applied based on a ground voltage, the driving configuration may be such that a scan pulse is be applied based on a positive voltage or a negative voltage.

Industrial Application

The present invention is applicable to display devices for use in information terminals, personal computers, etc., and PDP devices as image display devices for use in televisions etc.

1. A driving method for a plasma display panel device that includes a plasma display panel unit and a driving unit, the plasma display panel unit including first display-electrode pairs and second display-electrode pairs that are alternately arranged in parallel, each first display-electrode pair being a scan electrode and a sustain electrode arranged in a first order and each second display-electrode pair being a scan electrode and a sustain electrode arranged in a second order opposite to the first order, thereby scan electrodes in adjacent first and second display-electrode pairs are adjacent to each other and sustain electrodes in adjacent first and second display-electrode pairs are adjacent to each other, the driving unit driving the plasma display panel unit based on an intra-field time division gradation display technique, the driving method comprising:
a first step of applying, during an address period at a time of driving, a scan pulse to a plurality of scan electrodes selected from the first display-electrode pairs, sequentially in a direction based on the first order; and
a second step of applying, during the address period, a scan pulse to a plurality of scan electrodes selected from the second display-electrode pairs, sequentially in a direction based on the second order.

2. The driving method of claim 1, wherein
in the first step, a scan pulse is applied to all scan electrodes included in the first display-electrode pairs, sequentially in the direction based on the first order, and
in the second step, a scan pulse is applied to all scan electrodes included in the second display-electrode pairs, sequentially in the direction based on the second order, firstly from a scan electrode that is included in a second display-electrode pair and that is adjacent to a sustain electrode to which a scan pulse was lastly applied in the first step.

3. The driving method of claim 2, wherein
the direction based on the first order and the direction based on the second order each are a direction from an electrode with negative polarity to an electrode with positive polarity.

4. The driving method of claim 2, wherein
a first display-electrode pair that includes a scan electrode to which a scan pulse is firstly applied during the address period in the first step is a dummy electrode pair, and
during a sustain period at the time of driving, a sustain pulse is applied to display-electrode pairs other than the dummy electrode pair.

5. The driving method of claim 1, wherein
during the address period at the time of driving, a pulse with negative polarity is applied as a scan pulse to each scan electrode.

6. A plasma display panel device comprising a plasma display panel unit and a driving unit, the plasma display panel unit including first display-electrode pairs and second display-electrode pairs that are alternately arranged in parallel, each first display-electrode pair being a scan electrode and a sustain electrode arranged in a first order and each second display-electrode pair being a scan electrode and a sustain electrode arranged in a second order opposite to the first order, thereby scan electrodes in adjacent first and second display-electrode pairs are adjacent to each other and sustain electrodes in adjacent first and second display-electrode pairs are adjacent to each other, the driving unit driving the plasma display panel unit based on an intra-field time division gradation display technique,
wherein in an address period at a time of driving, the driving unit executes a first step of applying a scan pulse to a plurality of scan electrodes selected from the first display-electrode pairs sequentially in a direction based on the first order, and a second step of applying a scan pulse to a plurality of scan electrodes selected from the second display-electrode pairs sequentially in a direction based on the second order.

7. The plasma display panel device of claim 6, wherein
the driving unit applies, in the first step, a scan pulse to all scan electrodes included in the first display-electrode pairs sequentially in the direction based on the first order, and applies, in the second step, a sustain pulse to all scan electrodes included in the second display-electrode pairs sequentially in the direction based on the second order, firstly from a scan electrode that is included in a second display-electrode pair and that is adjacent to a sustain electrode to which a scan pulse was lastly applied in the first step.

8. The plasma display panel device of claim 6, wherein
a first display-electrode pair that includes a scan electrode to which a scan pulse is firstly applied during the address period in the first step is a dummy electrode pair, and
the driving unit applies, during a sustain period at the time of driving, a sustain pulse to display-electrode pairs other than the dummy electrode pair.

9. The plasma display panel device of claim 8, wherein
a black layer is provided on a surface of the plasma display panel unit at a display side thereof, at a position corresponding to the dummy electrode pair.

10. The plasma display panel device of claim 6, wherein
the scan electrodes or the sustain electrodes have an electrode construction including a transparent electrode.

11. The plasma display panel device of claim 6, wherein
the scan electrodes or the sustain electrodes have an electrode construction including a fence electrode composed of a plurality of metal lines.
